(19) United States
(12) Patent Application Publication
(10) Pub. No.: US 2004/0138973 A1
(43) Pub. Date: Jul. 15, 2004

(54) Method and system for exchange of currency related instructions

(75) Inventors: John T. Keis, Little Canada, MN (US); Larry Mitsch, St. Paul, MN (US); Suresh Srinivasan, Plainsboro, NJ (US)

Correspondence Address: SNELL & WILMER, ONE ARIZONA CENTER, 400 EAST VAN BUREN, PHOENIX, AZ, 850040001

(73) Assignee: American Express Travel Related Services Company, Inc., New York, NY (US)

(21) Appl. No.: 10/611,781

(22) Filed: Jun. 30, 2003

Related U.S. Application Data
(60) Provisional application No. 60/439,840, filed on Jan. 14, 2003.

(51) Int. Cl. G06F 17/60

(52) U.S. Cl. 705/35

(57) ABSTRACT

A component-based money movement system includes a central request processor that is coupled to various other components. The components may include an arrangement manager; a financial institution validator; a transaction manager; a remittance manager; a check writing manager; and an electronic payment manager. Each component performs specific tasks, each controlled by the request processor. Periodic arrangements can be created and stored by the arrangement manager. When arrangements are due, arrangement manager sends a message to the request processor, which sends a request to the appropriate component. The check writing component is configured to manage the check writing process, including printing the checks and keeping records of the printed checks. The remittance manager scans and processes incoming payments. The electronic payment manager generates electronic payment requests and stores data regarding the requests. The various components can be integrated into existing systems such that they can be used across an entire organization.

### CROSS-REFERENCE TO RELATED APPLICATIONS

This application claims priority from, and the benefit of, U.S. Provisional Application serial No. 60/439,840, filed Jan. 14, 2003, the entire contents of which is hereby incorporated by reference.

### FIELD OF INVENTION

This application generally relates to managing the exchange of information, and more particularly, to a computer-implemented method and system for routing instructions related to financial transactions.

### BACKGROUND OF THE INVENTION

Large financial organizations may have different units that perform numerous different functions related to the processing of money. For example, a financial institution may have a brokerage unit, a credit unit, a mortgage unit, a banking unit, and/or the like. In some cases, the various units are separated physically and functionally, such that each unit operates autonomously. An exemplary situation would be where an existing brokerage unit is merged with a financial institution. Because each unit may operate autonomously, each unit may have its own system for storing and accessing data. As such, in the situation where a single customer may have accounts with more than one of the units, the customer is forced to communicate with each unit separately. Thus, if a customer needs to make a payment to a credit unit and also send money to a brokerage unit, the customer is often forced to send two separate payments. If a customer wishes to transfer money between units, the process is typically more difficult because of the different systems. The differing systems usually result in the customer spending excessive time communicating with each unit.

In addition, the differing functions are also typically inefficient to the organization in that an organization often needs to create and maintain separate systems for each distinct unit. Moreover, upgrades of one unit are often needed to be propagated to the other units, if the organization wanted each unit to have the same system. In the alternative, each unit may have a different system, which may result in additional costs because of the need to maintain separate systems for each unit, and the subsequent need to have personnel separately trained in each of those systems.

These prior art systems also restrict flexibility and the responsiveness of the organization. For example, financial institutions periodically implement new rules which may be a result of new government regulations or may be implemented in an attempt to operate in a more efficient manner. However, under the prior art, it was often necessary to implement such changes multiple times, once for each unit. Also, with the wide variety of systems being used by an organization, it has become more difficult to integrate Internet functionality, which is becoming popular with end users which have various units. As such, a need exists for a centralized system of processing money within an organization which includes separate units.

### SUMMARY OF THE INVENTION

A system is disclosed which solves the above-described problems by including an enterprise-wide system containing several different modules. In one embodiment, a Request Processor is coupled to each of the following components: an arrangement manager; a financial institution validator; a financial transaction manager; a remittance manager; a check writing manager; and an electronic payment manager. The system may also include various front-end interfaces, such that users may access the various functions of the system.

The remittance processor is configured to process incoming payments or remittances. Incoming remittances are scanned and associated with a unique identification number. Thereafter, remittances are processed and the appropriate accounts are credited. In case of a problem with the remittances, the unique identification number can be used to locate the remittance for further processing. The financial transaction processor is configured to process financial transactions by receiving instructions from the request processor and formatting the instructions such that the instructions can be executed by the appropriate system. In such a manner, existing legacy systems can be interfaced with a system of the present invention.

The check writing manager is configured to generate paper checks. Upon receiving a request from the request processor, the check writing manager generates a print request to print a check including the appropriate amount. The check writing manager is also configured to ensure that the data regarding each check is stored and to ensure that the account from which checks are written have sufficient funds. The electronic payment manager performs similar functions as the check writing manager. However, the electronic payment manager is configured to generate electronic payment transactions (such as via ACH, FIX, and SWIFT) instead of paper checks. The arrangement manager is configured to create periodic arrangements, validate arrangements against pre-determined criteria, store arrangements, including a scheduled date, compare a current date with scheduled dates, and transmit messages regarding scheduled arrangements to the request processor.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 presents a block diagram overview of an exemplary embodiment of the present invention;

FIG. 2 presents a block diagram illustrating how an exemplary embodiment of the present invention can be implemented in an exemplary existing system; and

FIG. 3 is a flow chart illustrating exemplary steps taken to perform a periodic arrangement.

### DETAILED DESCRIPTION OF EXEMPLARY EMBODIMENTS

The present invention may be described herein in terms of various functional components and various processing steps. It should be appreciated that such functional components may be realized by a variety of different hardware or structural components configured to perform the specified functions. For purposes of illustration only, exemplary embodiments of the present invention will be described herein. Further, it should be noted that, while various components may be suitably coupled or connected to other components, such connections and couplings may be realized by a direct connection between components, or by a connection through other components and devices.

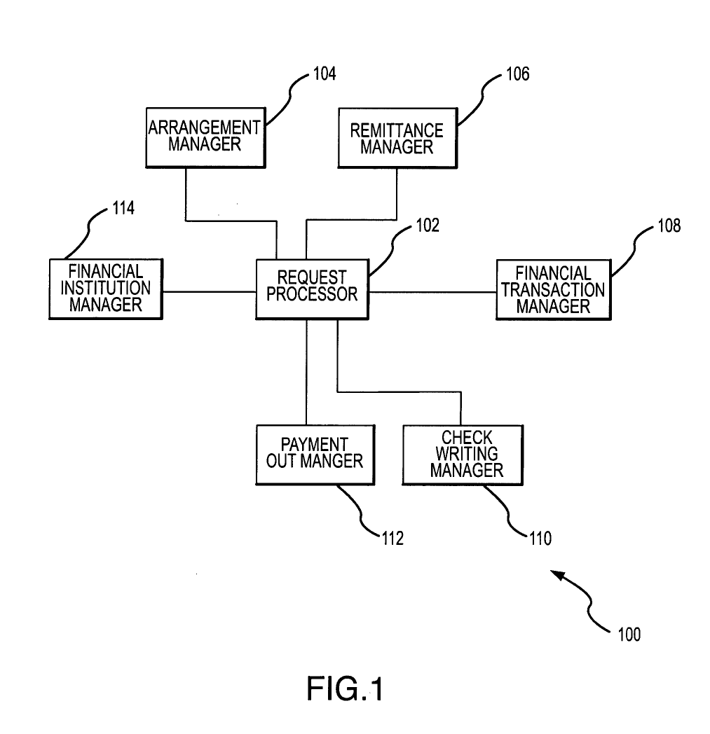

The invention includes a system and method for facilitating the processing of incoming and outgoing money from an organization in a standardized manner. An embodiment of the present invention is illustrated in FIG. 1. Apparatus 100 contains, in one embodiment, at least one of seven different components: Request processor 102, Arrangement Manager 104, Remittance Manager 106, Financial Transaction Manager 108, Check Writing Manager 110, Payment Manager 112, and Financial Institution Validator 114. Any combination of these seven components may operate together to enable an organization to process incoming and outgoing money in a standardized manner. Each of the components is configured to perform a portion of the tasks needed to process money as the money moves in the organization.

The system or each component may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, user computer will typically include an operating system (e.g., Windows NT, 95/98/2000, Linux, Solaris, etc.) as well as various conventional support software and drivers typically associated with computers. User computer can be in a home or business environment with access to a network. In an exemplary embodiment, access is through the Internet through a commercially-available web-browser software package.

Request Processor 102 includes a central component that facilitates communication with at least one of the other components of apparatus 100. Request Processor 102 can be set up such that it is the main component of apparatus 100. In such a situation, Request Processor 102 may be set up such that the remaining components 104-114 do not operate independently, but only upon receiving instructions from Request Processor 102. In one embodiment, Request Processor 102 is configured to facilitate validation and editing of customer arrangements against various rules. For example, certain types of transactions are regulated by the federal government or have certain reporting requirements. Request Processor 102 can help ensure that any such regulations are followed and the reporting requirements are fulfilled. Examples of such regulations are the reporting of deposits over a certain amount and the maintaining of a record of dividend and interest payments for reporting to the Internal Revenue Service on a regular basis.

The details of the regulations and reporting requirements are stored in a database that is accessible to Request Processor 102. As each transaction is processed, the transaction can be compared to the regulation and reporting requirements. If the transaction is not allowed (for example, depositing too much in to an Individual Retirement Account), the transaction may not be performed. If the transaction is allowed, but must be reported (such as cash deposits greater than the amount set by Federal regulations), the transaction can be executed, and the details of the transaction are stored in a separate table for later reporting to the correct agency.

In addition, an individual organization operating a system of the present invention may have its own rules. For example, an organization may have thresholds that only allow transactions that are over a certain amount, such as a minimum transfer into a mutual fund. Request Processor 102 may be configured to help ensure such internal regulations are followed as well, by preventing a user from establishing an arrangement that is not within pre-established rules. Internal rules may include, for example, account minimums, preventing users from holding tax-free securities in an tax-deferred account, daily limits on withdrawals, and/or the like. The internal rules may be stored in a separate database table. As each transaction is processed, it is compared to the internal rules to determine if the desired transaction is allowed. In another embodiment, the internal rules are stored in each component such that the rules are accessible by Request Processor 102.

Request Processor 102 may also facilitate performing various additional validations on requests. For example, the Office of Foreign Assets Control (“OFAC”) requires certain validations to be made to ensure that payments are not being made to or from a terrorist organization. These checks can be performed by Request Processor 102. These validations are known and may be implemented in a variety of different manners. For example, the various requirements may be stored in a database. As each transaction is processed, the request is compared to the requirements stored in the database. For example, funds from certain sources may be more highly scrutinized than funds from other sources, requiring a more thorough investigation of the account in question.

For example, information regarding incoming payments, handled by Remittance Manager 106, can be forwarded to Request Processor 102 to perform the OFAC validation. Additional validations may also occur. For example, a validation can be performed to detect fraud, such as the techniques disclosed in U.S. patent application Ser. No. 10/378,465, filed Mar. 3, 2003, the contents of which are hereby incorporated by reference.

Remittance Manager 106 is configured to facilitate processing incoming money and categorize the money into proper formats. In the prior art, a large financial institution may provide many types of financial services under the name of the financial institution. For example, a bank may provide banking services, credit services, and brokerage services. In the prior art, an entity may have accounts at various types at the same institution. For example, an entity may have a brokerage account, a credit account, and a bank account at the hypothetical financial institution described above. Each of such accounts may require monthly payments. In the prior art, even though each of the services were ostensibly provided by the same institution, separate payments needed to be made to each of the brokerage account, credit account, and bank account.

The Remittance Manager 106 of the present invention minimizes such a task. The Remittance Manager processes incoming money in a variety of different forms. Incoming funds may be in various forms, such as in electronic form, check, and money order. Remittance manager 106 contains various devices that can be used to process the incoming funds. For example, checks may contain an MICR code at the bottom of the check that contains a routing number and account number and can be read by various pieces of equipment to process the check in a more efficient manner. The data from the MICR code is then converted to the proper format for use and storage by Remittance Manager 106. Data from electronic fund transactions are converted into a format useable by Remittance Manager 106.

Money may be transmitted in a number of different manners, such as cash, check, and electronic transaction, such as via ACH. Remittance Manager 106 can process the transaction such that the incoming money is credited to the correct account.

Moreover, Remittance Manager 106 provides functionality in that incoming money may be processed and credited to multiple accounts. In the hypothetical situation presented above, where a single entity has a brokerage account, a credit account, and a bank account, the entity can send a single payment along with instructions as to how the payment is to be distributed. For example, the entity may send $12,000, with $4,000 going to each of the entity's three accounts. When a paper remittance (such as a check) is processed by remittance manager 106, the payment is typically accompanied by a record of the transaction, such as a payment stub. The transaction record and the payment are each assigned a unique trace ID code. The trace ID code is imprinted onto the transaction record by one of a variety of methods, such as the use of a magnetic ink, readable by MICR readers. Thereafter, the payment and the transaction record are processed separately. The trace ID can be used later, in the event of a problem in the processing of either the transaction record or the payment.

In the event of a problem, the trace ID can be used to associate the transaction record with the payment. In one embodiment, each transaction record may be scanned and stored electronically in a database, with each record associated with the trace ID. Thereafter, when a copy of the transaction record is needed, the database can be accessed and an image of the trace ID can be displayed. In this manner the transaction record can be compared to the transaction actually performed such that any discrepancy can be found and corrected.

Remittance Manager 106 may also be configured to capture scanned images of each incoming financial instrument and store each image in a database such that the image is associated with the corresponding account number. Such a process can be automated through technologies known in the art. Such scanned images can be used to ensure that any problems with the processing of the transactions, such as a dishonored check, can be confirmed against the scanned copy. In addition, such a scanning process can be used to convert the details of the financial instruments into an electronic form. Such a process can be accomplished by reading the MICR information printed on a check, which contains routing information, amount of transaction, and an account number. Once the data is in electronic form, the financial instruments can be processed by an ACH network, for electronic clearance of the financial instruments, or by various other methods now known or later invented. The information on the transaction record is used to ensure that the funds are distributed in the requested manner. A user can request, in the transaction record, to distribute the funds in multiple accounts. Such a request may be in a variety of different manners. For example, a user may fill out a paper form. The information in the form is then read, either by automated means or by a person, to distribute the funds. The appropriate accounts can then be credited with the requested payment amounts.

Arrangement Manager 104 is configured to facilitate storing both periodic and one-time requests from customers. Such requests may be, for example, to move funds in, out, and within a company. An entity may, for example, wish to make regular payments to its credit account or may wish to make periodic investments into a brokerage account. An entity may have multiple accounts with an institution, and wish to transfer funds among the accounts. An entity may wish to have periodic disbursements of funds. Such tasks can be managed by Arrangement Manager 104. One-time requests may also be managed by Arrangement Manager 104. One-time requests are those that are not periodic. For example, when a customer is in sudden need for money, the customer may wish to make a one-time withdrawal or transfer of funds. Conversely, when a customer has excess funds, the customer may wish to invest those funds and thus makes a deposit or transfers funds into an account.

There are many types of arrangements that can be stored. For example, a customer may wish to have $1000 transferred from one account to another at a predetermined time each month (or each quarter or any other interval). Such a transfer can be used to fund a retirement account, to pay a credit account, or various other purposes.

Arrangement Manager 104 is configured to store the various arrangements in a database. The arrangements may be entered by users by a variety of methods, including a web-based interface. Thereafter, the arrangements are stored in a database with a variety of information, including the date of the transaction, the amount of the transaction, and the affected account(s). Arrangement Manager 104 would store the information necessary to carry out such a transaction.

Arrangement Manager 104 may also be configured to facilitate performing validations on the requests, such that the requests are within various limits. For example, the Financial Institution may have a rule stating that deposits into a brokerage account have to be at least $1000. Arrangement Manager 104 may be configured to ensure that all periodic deposits to the brokerage account are at least $1000. Such a task can be performed in a variety of manners. One method would be to compare the amount of the transaction with a predetermined minimum and maximum. If the amount of the transaction is within the limits, the transaction is performed. If the amount is not within limits, the transaction is not performed and the customer may be notified in a variety of ways, such as through an e-mail, a letter, or a telephone call from a customer service representative.

Arrangement Manager 104 stores many or all of the arrangements for the various entities in a database. The database may be checked on a daily basis to find arrangements that are scheduled to occur on that particular day. Thereafter, Arrangement Manager 104 is configured to transmit a message to Request Processor 102 such that the arrangement can be handled by the appropriate component. Request Processor 102 typically has access to a database in which the appropriate components to perform a transaction are pre-defined.

Financial Institution Validator 114 is configured facilitate storing data regarding previously validated financial institutions with which transactions are performed. Such data may include, for example, an ABA routing transmit number; contact information including name, address, and telephone number; federal reserve district; ACH acceptance indicator; and account number format. Such data can be updated when needed, such as when two financial institutions merge. Data regarding newly created financial institutions may also be created within Financial Institution Validator 114. The data stored by Financial Institution Validator 114 may also be searched, in order to find information regarding a financial institution. Such a search may be performed to ensure that a particular electronic payment is directed to the correct financial institution. The financial institution information may be updated by comparing the data stored within Financial Institution Validator with information provided by a party that assigns routing numbers, such as Thomson Financial.

Financial Transaction Manager 108 is configured to facilitate generating the various instructions for the various transactions to be performed. For example, as described above, Arrangement Manager 104 may contain instructions regarding the periodic payment or transfer of funds. Financial Transaction Manager 108 communicates with Request Processor 102, which can then communicate with Electronic Payment Manager 112 and Check Writing Manager 110 to ensure that the various payment instructions are properly executed by checking confirmations provided by Electronic Payment Manager 112 and Check Writing Manager 110.

In one embodiment, Financial Transaction Manager 108 can be configured to communicate with existing legacy systems. In such a manner, as instructions are provided to Financial Transaction Manager 108 through Request Processor 102, the instructions are converted to the format used by the existing legacy system. Such a process may take place in a variety of different manners. For example, Financial Transaction Processor may have access to a database that contains the instructions used by existing legacy systems as well as an indication of the relationship between instructions on the legacy system and instructions on another system such that instructions can be translated.

In such a manner, older systems can be modernized by being able to communicate with apparatus 100 through Financial Transaction Manager 108. Such a situation may be desirable as the implementation of apparatus 100 can be done in stages, with existing legacy systems being used alongside components of apparatus 100.

Financial Transaction Manager 108 may also be configured to store information regarding each financial transaction in a database. Such information may include the date of the transaction, a unique transaction identification number, the payee information, and the amount of the transaction. Thereafter, statements can be generated on a periodic basis (such as monthly or quarterly) containing information about all the transactions on each account owned by each entity.

Check Writing Manager 110 is configured to facilitate processing outgoing payments by check. Payments sometimes may be needed for various customers. Such payments may include, for example, refund checks, to compensate the users for overpayment of their various accounts; and interest and dividend payments to customers with interest and dividend bearing accounts. Check Writing Manager 110 is configured to at least partially facilitate control of the check writing process. Such functions include ensuring that the check is printed in a correct format and ensuring that the account from which the check is written contains sufficient funds such that the check will be honored. In addition, the check numbers can be managed to ensure that check numbers are not duplicated and that a record of the outgoing checks are maintained in a database.

Electronic Payment Manager 112 is configured to facilitate processing and control of outgoing electronic payments. Electronic payments in the United States are typically handled via the ACH network, a nationwide network that provides for the clearing of electronic payments by financial institutions. The ACH instructions to make payments are formatted by Electronic Payment Manager 112 by referencing the standardized ACH format that is stored within a database accessible by Electronic Payment Manager 112. The ACH instructions are then sent to the appropriate financial institutions to be credited to the appropriate users.

Communications between the various components may take place in a variety of manners. In one embodiment, a messaging system, such as WebSphere MQ by IBM, is used to transmit information among the components in a standardized format. The format may include a standardized XML schema for the information.

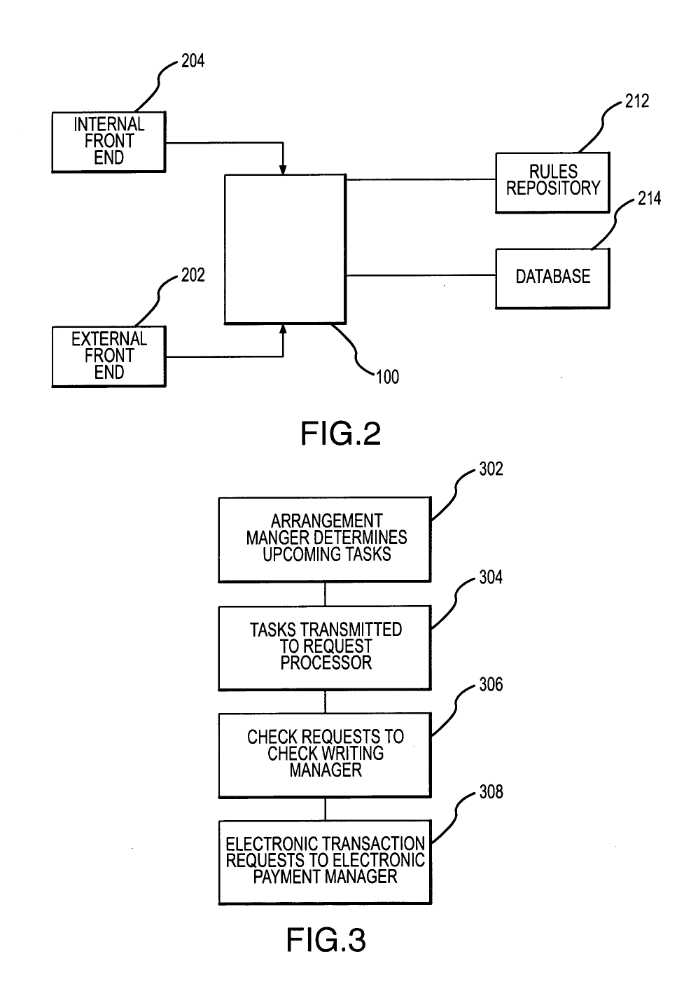

Any combination or all of the above described components may be integrated into an existing system. An example of such a system is shown in FIG. 2. Apparatus 100 (from FIG. 1) is coupled to at least one of Internal Front End 204 and External Front End 202. Both Internal Front End 204 and External Front End 202 are configured to accept the inputs of users and transmit the input to the appropriate component within apparatus 100. Both Internal Front End 204 and External Front End 202 may be a document that is readable by an Internet browser, such as, for example, Mozilla, Netscape Navigator, or Microsoft Internet Explorer. Such a document may contain forms or other methods of allowing user entry of data.

Internal Front End 204 is for internal use. It may be used by employees to change financial institution data for use in Financial Institution Validator 114 or to access customer account data when, for example, assisting a customer during a customer service call or in person at a bank or brokerage. External Front End 202 is for use by customers to access their financial records. Customers may wish to access their records to check the balances on their accounts or to make periodic arrangements or one-time arrangements. Both Internal Front End 204 and External Front End 202 are configured to communicate to Money Movement System 100 via a messaging system, such as WebSphere MQ. Money Movement System 100 is configured to communicate with systems such as rules repository 212 and a database 214.

FIG. 3 is a flowchart illustrating the operation of an embodiment of the present invention. In a hypothetical situation, Arrangement Manager 104 determines, on a daily basis, what tasks are to be performed that day (step 302). Arrangement Manager 104 is configured to store arrangements in a database. Among the information stored in the database is the scheduled date of a transaction and the desired transaction. Arrangement Manager 104 is configured to compare the current date (which is typically monitored on a real-time basis by a system clock) with the scheduled date of each arrangement stored in the database.

After determining the tasks to be performed as described above, Arrangement Manager 104 then transmits the tasks to be performed to Request Processor 102 (step 304). Request Processor 102 analyzes the scheduled tasks and transmits the tasks to the appropriate component for processing. In one embodiment, Request Processor 102 includes a database table that contains an association of each task with a component to perform the task. Each task that can be performed is pre-assigned with a component to perform the task and the relationship between the task and component is stored in the table. Thus, when a task is to be performed the performing component is determined and the task is transmitted to the pre-assigned component. The information regarding the tasks to be performed typically contains information such as, for example, a transaction amount, a form of the transaction, and the destination of the transaction. For example, a task to be performed may be to withdraw $1000 from one account and send a check in that amount to the account owner. In such a situation, a request is sent to Check Writing Manager 110 to complete that task (step 306). The scheduled task may be for an electronic transaction instead, such as an electronic deposit into a bank account or an electronic withdrawal from a bank account. In that case, a request is sent to Electronic Payment Manager 112 (step 308).

Other requests are sent to Financial Transaction Manager 108. For example, a task may be to purchase or sell securities or to use an existing legacy system. Such a task is sent by Request Processor 102 to Financial Transaction Manager 108, which formats the task such that it is readable by the existing legacy system (step 310).

Not all transactions are pre-arranged and stored in Arrangement Manager 104. For example, payments may not be pre-arranged, but be sent in the form of a check. In such a situation, Remittance Manager 106 processes the remittance in the manner described above. The information obtained by Remittance Manager 106 can then be transmitted to Request Processor 102 for record keeping purposes. In some embodiments, Request Processor 102 may transmit the information to Financial Transaction Manager 108. Thereafter, Financial Transaction Manager 108 may be configured to generate the instructions used to credit and debit the appropriate accounts.

In some embodiments, the mechanism used to credit and debit the appropriate accounts may be an existing legacy system. In other embodiments, a new mechanism may be created to handle the actual financial transactions. In either situation, Financial Transaction Manager 108 generates the appropriate instruction for use by the appropriate mechanism.

The present invention is described herein with reference to block diagrams, flowchart illustrations of methods, systems, and computer program products according to various aspects of the invention. It will be understood that each functional block of the block diagrams and the flowchart illustrations, and combinations of functional blocks in block diagrams and flowchart illustrations, respectively, may be implemented by computer program instructions. These computer program instructions may be loaded on a general purpose computer, special purpose computer, or other programmable data processing apparatus to produce a machine, such that the instructions which execute on the computer or other programmable data processing apparatus create means for implementing the functions specified in the flowchart block or blocks.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded on a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention.

Benefits, other advantages, and solutions to problems have been described above with regard to specific embodiments. No element described herein is required for the practice of the invention unless expressly described as “essential” or “critical.”

We claim:

1. A system for facilitating the management of financial transactions comprising:
a request processor coupled to at least one of a remittance processor, arrangement manager, financial institution validator, financial transaction manager, electronic payment manager, and check writing manager, wherein:
said remittance processor is configured to process incoming payments;
said arrangement manager is configured to perform specified, periodic events;
said financial institution validator is configured to validate data regarding external institutions;
said financial transaction manager is configured to process and execute various financial transactions;
said electronic payment manager is configured to process outgoing electronic payments; and
said check writing manager is configured to process checks.

2. The system of claim 1 further comprising at least one of a front-end for internal use and a front-end for external use.

3. The system of claim 1 wherein the financial transaction request processor facilitates communication via a messaging system.

4. The system of claim 1 wherein the remittance processor is further configured to facilitate:
scanning incoming remittances into an electronic format;
assigning a unique identifier to each remittance; and
storing said unique identifier with data regarding the incoming remittance.

5. The system of claim 1 wherein said financial transaction processor is configured to facilitate:
receiving instructions from said request processor;
translating the instructions into a format readable by another system; and
transmitting the translated instructions to another system.

6. The system of claim 1 wherein said check writing manager is further configured to facilitate:
receiving a request to write a check;
formatting said request;
sending a print request to a printer; and
storing data regarding each print request in a database.

7. The system of claim 1 wherein said electronic payment manager is further configured to facilitate:
receiving a request to perform an electronic transaction;
formatting said request into a form usable by an electronic payment network;
sending said formatted request to an electronic payment network; and
storing data regarding each request in a database.

8. The system of claim 1 wherein said arrangement manager is further configured to facilitate:
creating periodic arrangements;
validating arrangements against pre-determined criteria;
storing arrangements, including a scheduled date;
comparing a current date with scheduled dates;
transmitting messages regarding scheduled arrangements.

9. The system of claim 1 wherein said request processor is further configured to facilitate:
validating transactions; and
directing transactions to an appropriate component.
